(19) United States
(12) Patent Application Publication
(10) Pub. No.: US 2006/0248079 A1
(43) Pub. Date: Nov. 2, 2006

(54) Method and apparatus for finding a perfect hash function and making minimal hash table for a given set of keys

(75) Inventor: Philip R. Braica, New Boston, NH (US)

Correspondence Address: GORDON E. NELSON, PATENT ATTORNEY, PC, 57 CENTRAL STREET, P.O. BOX 782, ROWLEY, MA, 01969, US

(73) Assignee: Freescale Semiconductor Incorporated

(21) Appl. No.: 11/116,648

(22) Filed: Apr. 28, 2005

(51) Int. Cl. G06F 7/00

(52) U.S. Cl. 707/7

(57) ABSTRACT

A representation used in a computer system to represent a set of data items that correspond to and are accessible by means of a set of keys. The representation includes an array of the data items and a bit string associated with the array. Each key is mapped onto a bit of the bit string by means of a hash function that is perfect for the set of keys. The mapped bit is set. The data item corresponding to the key has a position in the array that corresponds to the position of the bit for the key in the bit string. Methods for reading and writing the representation are disclosed as well as a technique based on the mod operation and a set of co-prime numbers for finding a perfect hash function for a given set of keys.

### CROSS REFERENCES TO RELATED APPLICATIONS

The subject matter of this patent application is closely related to the subject matter of patent application U.S. Ser. No. xx/xxx,xxx, Compressed representations of tries, which has the same inventor and assignee as the present patent application and is being filed on even date with this application. U.S. Ser. No. xx/xxx,xxx is further incorporated by reference into this patent application for all purposes.

### BACKGROUND OF THE INVENTION

1. Field of the Invention

The present invention relates generally to computer systems, and more specifically to techniques for locating data through the use of a hash function.

2. Description of Related Art

In computer systems there is a constant effort to reduce the amount of storage and time required to locate data. This is especially true with devices such as routers and switches that route Internet Protocol (IP) messages in a network. Such devices have a limited amount of memory and must route messages as rapidly as possible.

FIG. 1 shows a prior art means of looking up data associated with an IP address. An IP address is a 32 bit datum. It is normally expressed in eight bit quantities called octets where each 8 bits of the 32 bits is separated by “.”. Each octet has a range of 0 to 255. The expression of addresses can be seen in the column marked ADDRESS in the table 103. If the first octet of the IP address is used as a key to look up data, the simplest means of finding the associated data is to store it in an array of 256 elements using the first octet of the address as an index into the array. This method is simple and fast, but it is not minimal in that the array of 256 elements is sparsely populated, with only 7 elements occupied by data.

To reduce the amount of memory required to store the seven elements of the table, a technique called hashing is used. Hashing is implemented using a hash function. The hash function is passed a string of bits commonly referred to as a key and returns a hash value that is associated with the key. The hash value is typically used as an index into a hash table, a hash table being an array of data elements of a known size. The array element referenced by the hash value contains the data associated with the key. In the Internet switching context, the data is typically a pointer to routing information that is associated with the key.

The input and output of a hash function can be expressed as hash_value=ƒ(s), where s is the key. The form of a hash function is implementation dependent, but a typical hash function is ƒ(s)=s mod p. The modulus is used because it returns the remainder of s divided by p and therefore allows an array of p elements to be used as the hash table. FIG. 1 shows at 101 a prior art technique for hashing a set of keys. Technique 101 transforms a set of IP addresses 103 using a hash function and a hash table. The top octet of the IP address is used as a key. The key has a range of values of 0 to 255. Hash function 105 is said to be perfect for a set S of octets if the value of p used in the hash function has been chosen such that none of the keys produce the same hash value when applied to s mod p. If two of the keys produce the same hash value, a collision occurs. In order to prevent a collision from occurring, it is necessary to have a hash function 105 that indexes into a hash table 107 where no collisions occur. Value p in hash function 105 also defines the size of hash table 107. The obvious shortcoming of this is method is that the hash table is sparsely populated. (i.e. the table is not minimal in that there are not an equal number of elements and keys) There is more space wasted in the hash table 107 than used. The sparseness of hash table 107 could be even greater if the modulus required to produce a perfect hash in function 105 were greater than 16.

An alternate prior-art technique for hashing a set of keys which allows for smaller initial memory allocation is hash chaining. FIG. 2 illustrates an implementation of this technique at 201. A hash table of this type has as its base component a structure that allows the storage of a key, data, and pointer to the next entry in the chain. The following C structure defines a possible implementation of such a structure:

```
struct hash_element {
    int key;
    char data[256];
    struct hash_element *next;
};
```

To implement a hash table a programmer initially allocates an array of n elements, where n is a prime number chosen for its value in proximity to the number of elements that need be stored in the table. Hashing technique 201 has array 203 containing seven elements. Data corresponding to the set of keys S 225 is inserted into array 203 using the hash values produced by hash function 227 from the keys as indexes into array 203. Inserting the data corresponding to the first three keys 0,6, and 2 of set S 225 using the results of the hash function 225 inserts the data in elements 205, 213, and 209 respectively of array 203. At this point the hash function is perfect, as no collisions have been encountered. Insertion of the data corresponding to the fourth key of the set S 227 causes a collision, as the result of the hash function for the value 9 will return a hash value of 2. There already exists data with an index of 2, the element 209. An additional hash_element is allocated with the data and the key 9 being stored in the new element 211. The element 209 is updated to also include the address of element 211 as the next element in the chain. Insertion of the data with the key of 19 causes the key and data to be stored at element 5 of array 215. Inserting data with a key of 12 causes hash function 225 to return an index of 5. An additional hash_element is allocated with the data and the key 9 being stored in new element 217. Element 215 is updated to also include the address of element 217 as the next element in the chain. Inserting data with a key of 5 causes an additional hash element to be allocated 219 with the key and data being stored in the element. Element 217 is updated with the address of element 219 as the next element in the chain.

As is evident from table 203, using a hash function to determine the location of data results in varying numbers of memory accesses to fetch the data associated with the key. Data elements at 205, 209, 215, and 213 can each be accessed with a single memory reference, while the data elements at 211 and 217 each can be accessed with two memory references. Accessing data element 219 requires three memory references. The more memory references, the more time it takes to access data associated with a key. In addition to the differences in time required to reference data elements, table 203 is memory inefficient. Original array 203 contained seven elements, which equals the number of elements that needed to be stored in the table. Three additional elements were allocated in discrete memory locations while locations in the original array 207, 221, and 223 remained empty. Additionally, the key and pointer must be stored with the data to allow collisions to be resolved. Hash function of 201 can be said to trade off time for space, whereas the hash function 101 trades space for time.

What is needed to overcome the foregoing problems of hash table sparseness and inequality of time to reference data is a method of finding a perfect hash for a given set of keys and storing the data corresponding to the set of keys in a minimal hash table. It is an object of the present invention to provide such a technique. Other objects and advantages will be apparent to those skilled in the arts to which the invention pertains upon perusal of the following Detailed Description and drawing, wherein:

### BRIEF DESCRIPTION OF THE DRAWING

FIG. 1 shows a prior art hash function, set of keys, and hash table.

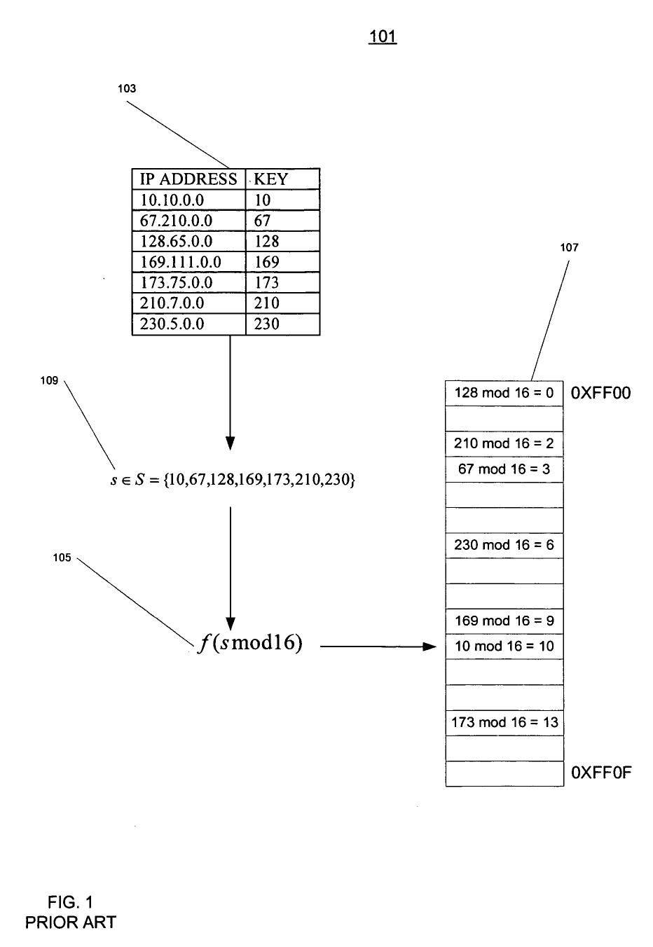

FIG. 2 shows a prior art chain method hash table populated with a set of keys.

FIG. 3 shows a representation of a perfect hash function and the hashed values produced by applying the perfect hash function to a set of keys and how the representation may be used to obtain addresses of data corresponding to the keys.

FIG. 4 shows a block of code for finding a perfect hash function for a set of keys.

FIG. 5 shows a block of code for producing the representation of the perfect hash function and the hashed values.

FIG. 6 shows a block of code that uses the representation of the perfect hash function and the hashed values to produce an address of the data corresponding to a given key.

FIG. 7 shows a flow chart of the logic required to find a perfect hash function for a set of keys.

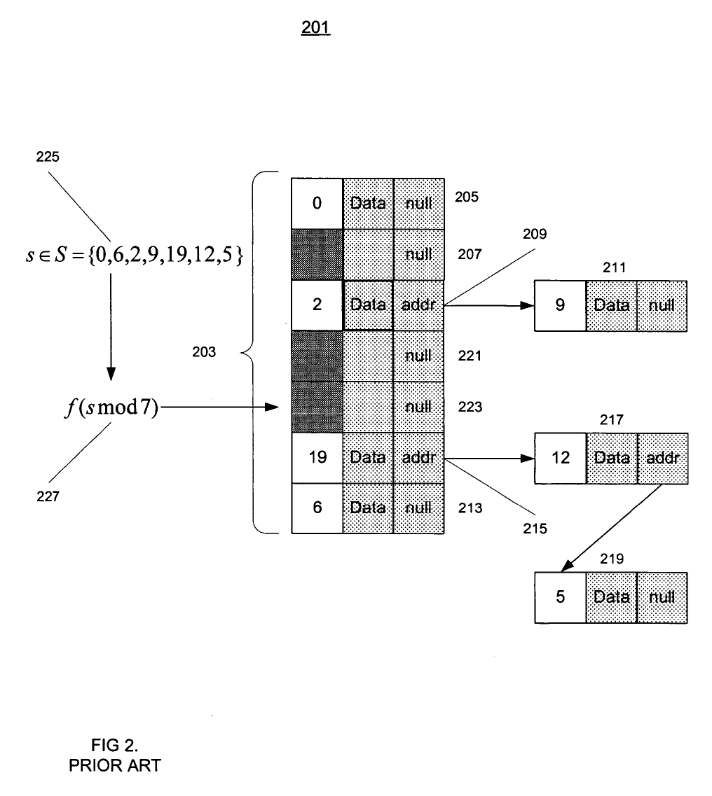

Reference numbers in the drawing have three or more digits: the two right-hand digits are reference numbers in the drawing indicated by the remaining digits. Thus, an item with the reference number 203 first appears as item 203 in FIG. 2.

### DETAILED DESCRIPTION

The first part of the present invention is a technique for finding a perfect minimal hash function for a given small set of keys. The second part is a technique for making and using a bitmap representation of the perfect hash function.

Finding a Perfect Hash Function

The Mathematics of Finding a Perfect Hash Function

In the area of Internet Protocol Routing it is often observed that a small set of keys will have values belonging to a large range of values. When this is the case, the keys are said to sparsely populate the range of values. The set of IP addresses 103 illustrates a small set of seven keys with a range of 256 possible values. Often such a set will contain only contain 4-6 keys. For the moment it is assumed that the set has only two keys, S={s₁, s₂}. Then given the function hₚ(s)=s mod p where p is a prime number pε{1,2,3,5,7,11,13, . . . ,} a collision occurs whenever hₚ(s₁)=hₚ(s₂). If p=2, both s₁ and s₂s are even, then h₂(s₁)=h₂(s₂)=0 and the keys collide. If both keys are odd, then h₂(s₁)=h₂(s₂)=1 and they still collide. So it can be quickly determined whether for a given two keys a hash function is perfect.

If the set of keys is increased, a perfect hash may be found for the set of keys by using the Chinese remainder theorem. The Chinese remainder theorem states that is possible given the remainders an integer gets when it's divided by an arbitrary set of divisors to uniquely determine the integer's remainder when it is divided by the least common multiple of those divisors. Using the theorem it possible to show that the smallest value of the set of keys is hₚ(s₁)=hₚ(s₂) for all possible values of p. Where
p=2 h₂(s₁)=h₂(s₂) forces s₂=2a₂+s₁
p=3 s₂=3a₃+s₁
p=5 s₂=5a₅+s₁
. . .
a₂ is an integer greater than zero. In order for p=5, p=3 and p=2 cases to be true, then s₂=5*2*3*a₂+s₁ or the minimum 5*2*3+s₁.

An object of the invention is to find a set of values of p for a given set of keys such that at least one of the hash functions s mod p is perfect. To find such a set of values of p, a set of co-prime numbers is used rather than prime numbers. A set of numbers are co-prime if they do not share a common set of factors. A set of co-prime factors less than 32 is:
pεP={31,29,28,27,25,23,19,17,13,11}.
This means that for any key s₁ the next largest key that collides with it for every hₚ(s)=s mod p is s₂=31*29*28*27*25*23*19*17*13*11+s₁=18,050,444,111,700. The set of P is chosen as an example, the actual set is an implementation detail.

Where hₚ(s)=s mod p where p is a co-prime number pεP={31,29,28,27,25,23,19,17,13,11} and there are only two keys, as long as the keys are less than 18,050,444,111,700 (less than 44 bits), then there exists a hash function that is perfect for some pεP. This means that for keys less than 48 bits as in internet bridging, it is 1,099,511,627,776:1 odds that a perfect hash function exists where pεP. Because an initial hash has pre-sorted the keys, the odds of not finding a value of p which yields a perfect hash function for the keys are extremely low.

If there are three keys, then the p=2 condition is:
p=2 h₂(s₁)=h₂(s₂) or h₂(s₁)=h₂(s₃) or h₂(s₃)=h₂(s₂)
forces sᵢ=2a₂+sⱼ where a₂ some integer greater than zero for some sᵢ, sⱼ i≠j. Thus if there are N keys, one key doesn't need to be the product of the members of P. The product of some of the members of the set P make up part of the value of each key. Thus if there were three keys, and the smallest was s₁, s₂ could be 11*13*17*19*23+s₁, and s₃ could be 25*27*28*29*31+s₁. Thus the size of the first key that prevents the family of hash functions from being perfect drops very quickly as the number of keys N increases. This means the statistical likelihood of having two keys that collide increases with N.

Whenever a failure to find a hash occurs, the initial hash function can be recomputed to use the next set of co-prime numbers available. An alternative, is to create another level of hashing, with keys that result in collisions when applied to a first hash function being then applied to a slightly different hash function. If a collision occurs that cannot be resolved at the first level, the number of keys at the second level will be reduced, making it easier to find a perfect hash function at the second level. Modifying the hash function to be h(x)=(c*x) mod p where c is a large prime number reduces the odds of failure to zero.

An alternative method of resolving collisions is to create an additional hash table chained from the first that employs a hash function that is perfect for the keys the collide in the first hash table. Statistically, whether the first hash is likely to succeed is based on the amount of memory allocated. The remaining collisions have odds of failing around 18,050,444,111,700 to 1. In a third hash, the odds of a collision are over 18,050,444,111,700² to 1. For a fourth hash the odds of a collision is 18,050,444,111,700⁴ to 1. There are not enough possible keys to need more than a second hash using any of the internet routing key forming strategies in current use. A key that does not work using the method of the current invention is hundreds of bits long.

Finding a Perfect Hash Function for a Given Set of Keys

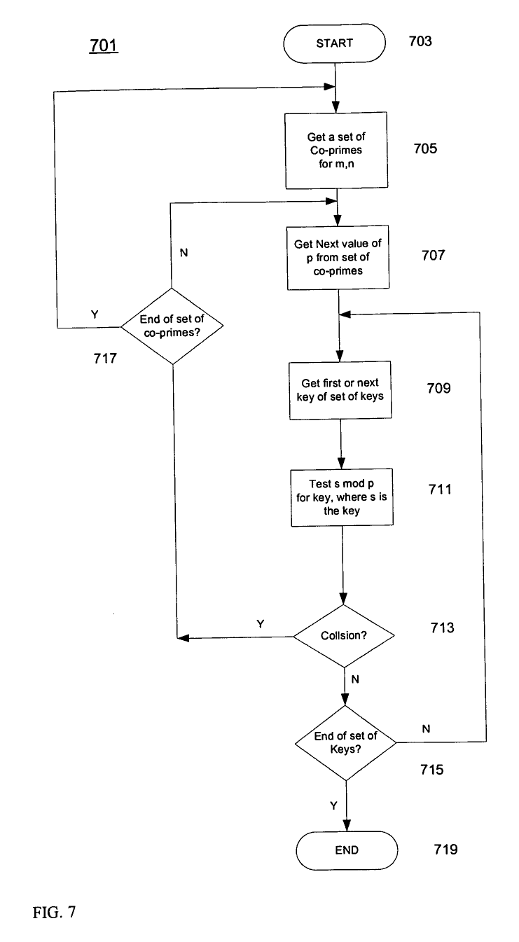

FIG. 7 is a flow chart of a method of finding a perfect hash function for a given set of keys. At 703 the method is entered with a set of keys. A set of co-prime numbers is produced at 705. The initial set of co-prime numbers is the set of co-prime numbers less than 32. If an alternate set of co-primes is required, then expand the set to co-prime numbers larger than 32. At 707 get the next co-prime number p from the set of co-prime numbers. At 709 get the next key from the set of keys. At 711 test each member of the set of keys to determine if there is a collision when s mod p is computed with the current values of s and p. If a collision has occurred 713, then determine if there are still elements left in the current set of co-prime numbers 717. If there are additional elements in the current set of co-prime numbers, then branch to 707. If a collision has not occurred 713, then test if all of the keys in the set of keys have been tested 715. If all the keys have not been tested, get the next member of the set of keys 709. If all the keys of the set of keys have been tested and no collision has occurred, then a perfect hash function has been found 719.

The method of FIG. 7 may be used with hash functions other than s mod p, and the method may be set forth more broadly as a method of finding a hash function ƒ(s,p) for a set of keys. The steps of the method are:

defining a set of values P such that P has a high probability of including a value p such that ƒ(s,p) is perfect for the set of keys; and

repeating the steps of
selecting a value of p from P; and
testing ƒ(s,p) with the selected p and the set of keys to determine whether ƒ(s,p) with the selected p is perfect for the set of keys
   until a value of p is found for which ƒ(s,p) is perfect for the set of keys or all of the values of p have been tested.
   Using a Perfect Hash Function to Translate a Set of Keys Into Entries in a Minimal Hash Table

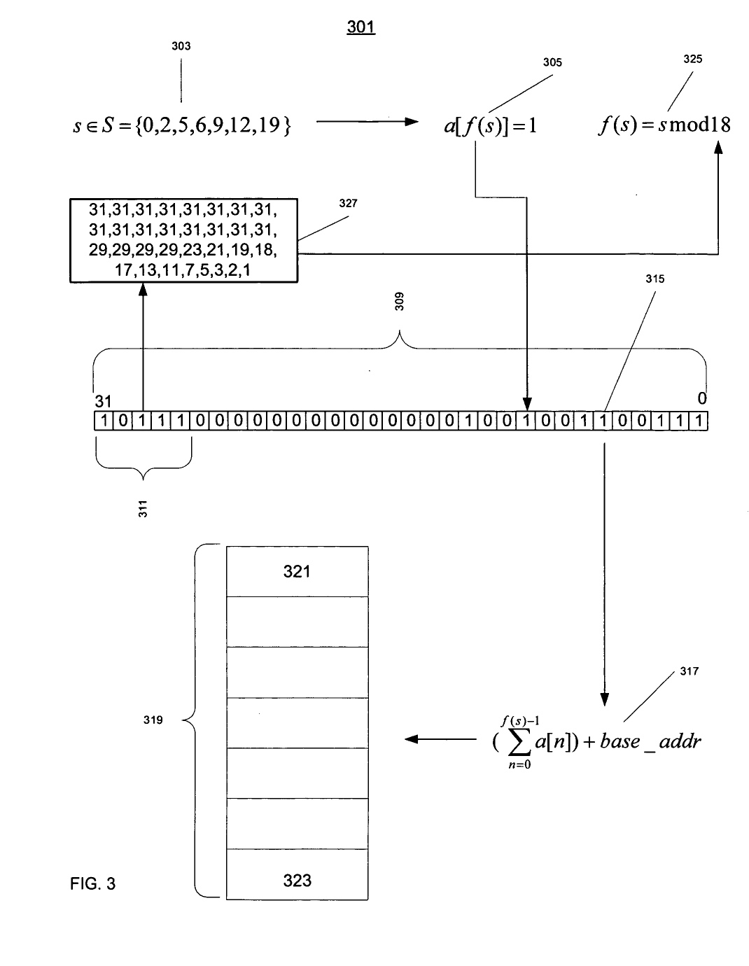

FIG. 3 is a diagram of the translation of a set of keys into a minimal hash table. The set of keys 303 is translated into indexes using a perfect hash function 305. Perfect hash function 305 is expressed at 325 as s mod 18. Each translation produces an index, the index being used to turn on a bit in the bit string 309. The bit string 309 contains two values: a specification of the value of p used in the perfect hash function and a bit string which has a bit for each of the values in the range of values produced by the hash function. If a key hashes to a given value, the bit for that value is set. In FIG. 3, the specification of the value of p is at 311, which contains an index into a table 327 of valid values of p. Bits 311 also are used for bits of the range of values produced by the hash function. The value of p specified at 311 is the value of p in the hash function that was used to create string 309. Bit string 311 can hold both types of data because there is a table for translating the index 311 that accounts for the overlapping data. The translation of data takes place by using index 311 in table 327, which here is an array of co-prime numbers 327 having values less than 32. The choice of a maximum value less than 32 means that bit string 309 need have only 32 bits. The value referenced by the index is used as p in function 325. As should be clear from array 327, both the index for the value of p and the bits for the range of values produced by s mod p can be stored in 311 because bit 31 is not used and bits 27-30 index into the first 16 elements of array 327. The value in 311 is 23, which is the index of the value 18 in array 327. Set bits in the remainder of bit string 309 indicate valid indexes made from the set of keys. Once a valid index in the bit string 309 has been located, function 317 transforms the index in the location of the data in array 319. Function 317 sums all the set bits in bit string 309 that precede the index resulting from the application of function 305 to the current key. Table 319 contains only entries corresponding to set bits in string 309, and consequently table 319 is minimal with regard to the set of keys and the hash function that are used to produce string 309. While transformation 301 assumes a hash function of s mod p for function 325, it should be clear to those skilled in the art that any function ƒ(k,c) can be used where the set of values returned by the function has no more members than there are available bits in string 309, k is a key belonging to a set of keys K, c belongs to a set of values C, and there is at least one value of c in C for which ƒ(k,c) produces no collision for all keys k in K.

In FIG. 3, the perfect hash function is used to map keys onto bitstring 309. However, any technique which results in such a mapping may be used. Another such technique is disclosed in patent application U.S. Ser. No. xx/xxx,xxx, Compressed representations of tries, in which the keys are associated with nodes in a trie of stride 1 and the nodes of the trie are mapped onto a bitstring, with the bit corresponding to a node that has an associated key being set. Additionally, any string of symbols may be used instead of the bitstring, as long as all of the symbols corresponding to the keys are set to a value that indicates that the symbol corresponds to a key. Further, an array or any representation of data that has the characteristics of an ordered set may be used to store the data associated with the keys. There may be any relationship between the positions of the set symbols in the string of symbols and the positions of the corresponding data in the array, as long as the corresponding data in the array can be located from the position of the symbol in the string. Thus, a set of data associated with a set of keys may be represented using the following elements:

a string of symbols, the value of a symbol in the string indicating whether the symbol corresponds to one of the keys in the set; and

an ordered set of the items of data wherein there is an item of data corresponding to each symbol that corresponds to a key and the position of the item of data in the ordered set being such that the item of data may be located using the position of the symbol onto which the key has been mapped.

The ordered set need only contain entries for the items of data, so the representation can be as small as the amount of memory required for the items of data plus the amount of memory required for the string of symbols.

Methods used to write or read a representation of a set of data associated with a set of keys that has the above form are not dependent on the manner in which the keys are mapped to the string of symbols. A method of making the representation has the following steps:

for each key in the set of keys,
mapping the key onto a symbol of the string of symbols;
setting the symbol onto which the key has been mapped; and
placing the item of data associated with the key in an ordered set of the items of data, the position of the item of data in the ordered set being such that the item of data may be located using the position of the symbol onto which the key has been mapped.

A method of reading the representation has the following steps:

mapping the key to a set symbol in the string of symbols;

determining the position of the set symbol relative to other set symbols in the string; and

using the position of the set symbol to locate the item of data corresponding to the key in the ordered set.

Implementation of a Method of Finding a Perfect Hash Function

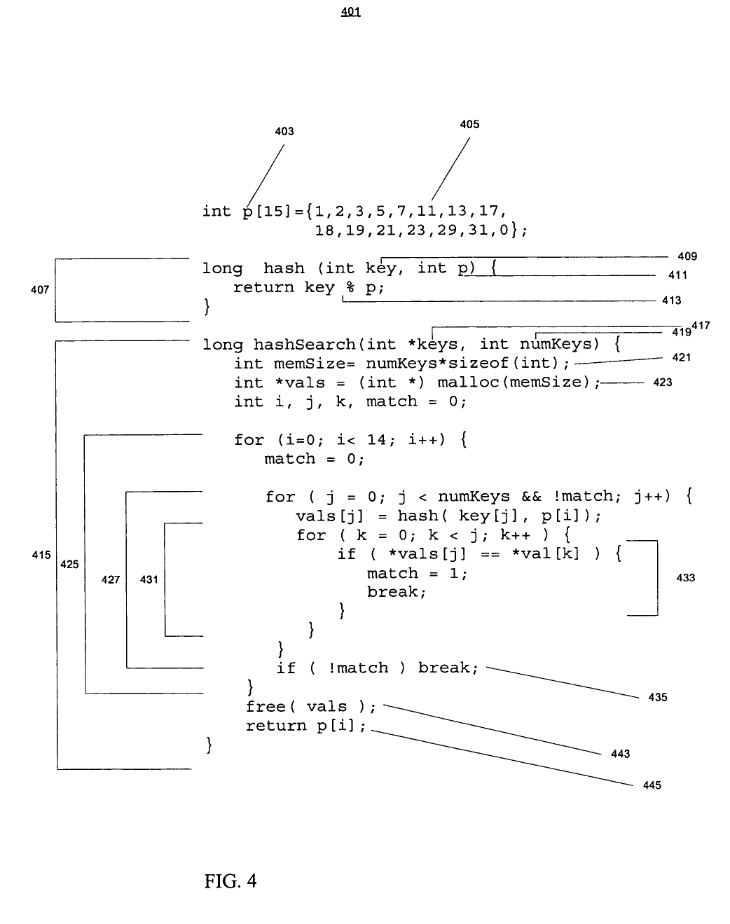

FIG. 4 shows C language code for finding a perfect hash function for a given set of keys. First a static array 403 is defined and the array is instantiated with the set of co-prime numbers whose values are less than thirty-two 405. Array 405 is terminated with the value zero, which is not a member of the set of co-prime numbers. A block of code 407 defines a hash function key mod p 413 that returns a hash value. The hash function is passed hash key 409 and a value p 411. The value p 411 is a member of the array of co-prime numbers 403.

To find a hash function s mod p that is perfect for a given set of keys, function hashSearch 415 is defined. Function hashSearch 415 is passed a pointer to an array of keys 417 and an integer 419 containing the number of elements in array 417. The function allocates memory 421 to store an index obtained using key mod p for each member of array of keys 417. Block of code 425 iterates through the set of co-prime numbers stored in array p 403. Block of code 427 iterates through the set of keys stored in the array pointed to in keys 417 for a current value of p. The current value of p is specified by an index i into array 405 of co-prime numbers. The hash values for the current iteration of set of keys 427 and current value of p are stored in memory 423. Block of code 431 compares the hash index 421 for the current iteration of set of keys 427 against all previous hash indexes 421 for the current iteration of the set of keys 427. If any of the previous indexes are equal the current index then a collision has occurred and the iteration 431 for the current key is ended 433. If all keys were iterated through without finding a matching hash index 435, then a perfect hash function has been found for the given set of keys and the iteration is ended 435. If the iteration 425 is complete without locating a perfect hash function, return zero, the last element in the array p 403. If iteration 425 finds a perfect hash function, then return the value of p in s mod p from the array p 403 as indexed by the value of i in iteration 425. In a preferred embodiment there are multiple sets of the array 405, the alternate sets being used when a perfect hash is not found in a first iteration.

Implementation of a Method to Produce a Representation of a Perfect Hash Function for a Set of Keys

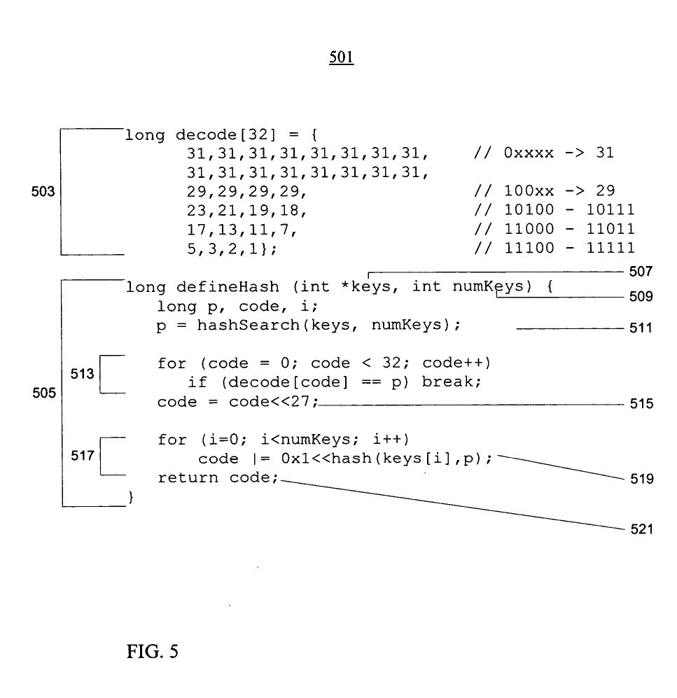

FIG. 5 shows C language code 501 that produces bit string 309. Function defineHash 505 returns a 32 bit encoded word 309 that represents a perfect hash function for a given set of keys (311) and the hash values that result from applying the perfect hash to the given set of keys. The perfect hash function is represented at 311 by the index in array 503 of the value of p used in the perfect hash function and the hash values are represented by set bits in encoded word 309. Array decode 503 defines an array of possible values of p that can be returned from hashSearch 415. Function defineHash 505 is passed a pointer to an array of keys 507 and number of keys 509. DefineHash 505 calls hashSearch 415, passing the pointer to array of keys 507 and number keys of 509 to find p 511 to be used by hash function 407. Block of code 513 iterates through the array of possible values of p 503 to determine which element of array 503 matches p 511. At 515, the index of the iteration 513 is shifted into the top five bits 311 of encoded word 309. Block of code 517 iterates through array of keys 507 getting the index, which hash function 407 computes using the value of p 511. At 519, a bit corresponding to the index returned from the hash function is set in encoded word 309. Encoded word 309 is returned to the caller at 521. The logic in 501 is shown in 305 transforming set of keys 303 to array of bits 309 combined with a decode value 311. In a preferred embodiment there are multiple sets of the array 503, the alternate sets being used when a perfect hash function is not found in a first iteration.

Using the Representation of the Perfect Hash Function and the Minimal Hash Table to Find the Address of Data Corresponding to a Given Key

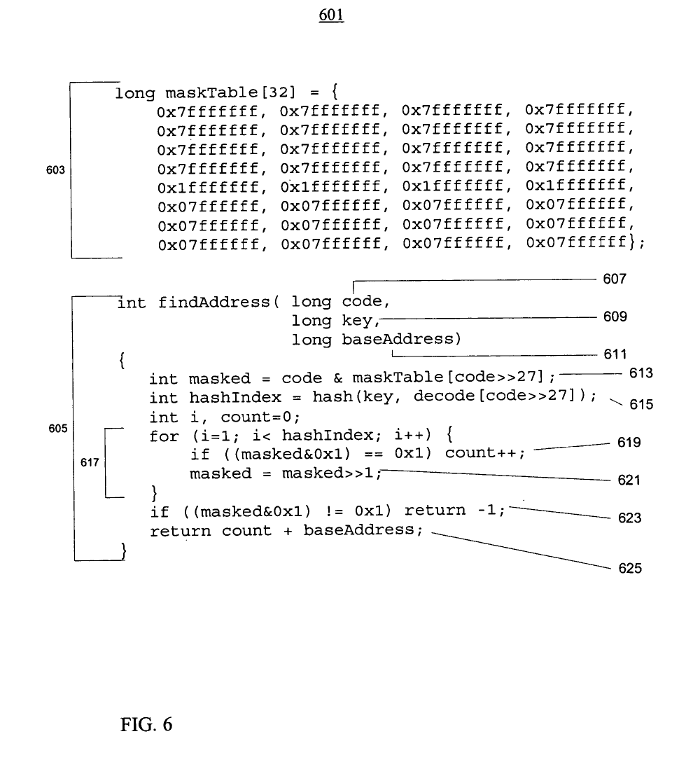

FIG. 6 illustrates how the address of the data corresponding to a given key can be found using bit string 309 and the hash function specified in bit string 309. C code 601 begins by defining an array maskTable 603 that contains values for masking off the most significant bits of code 607, which is the encoded bit string 309 produced by defineHash 505. The function findAddress 605 is passed code 607, a key 609 for which the corresponding data is to be found, and a baseAddress 611 for array 319 which contains the corresponding data. The address of the data corresponding to the key is found using baseAddress 611 and the hashed value produced by applying s mod p with the value of p specified at 311 to the key. The first step is to get the value of p from field 311. (613) The next step 615 is to use the value of p to determine the hashed value for the key. The hashed value is used to locate the bit in string 309 that corresponds to the key. Next, loop 617 iterates through bit string 309, counting every set bit (619) where the index is less than the index returned from the hash function 615. If bit map index for the index returned by the hash function is not set, return −1 623 indicating the key was invalid. Otherwise, compute the location of the data by adding the count of valid bits to baseAddress 525. The logic in 601 is shown at 317 transforming a key form a bit string 309 to an address in array 319.

### CONCLUSION

The foregoing Detailed Description has disclosed to those skilled in the relevant technologies how to make and use the inventions claimed herein and has also disclosed the best mode presently known to the inventor of making and using the inventions. It will be immediately apparent to those skilled in the relevant technologies that apparatus and methods embodying the inventions may be implemented in many ways other than those disclosed herein and also for many other purposes. For example, as disclosed herein, the invention is used to represent and look up data that is associated with an IP address; it can, however, be used in any situation in which a key is used to locate data.

The mapping of keys to symbols in the string of symbols may be done using any available technique and the symbols may have any form from which it may be determined that the symbol corresponds to a key. The data may be contained in an array, but it may have any other representation which has the characteristics of an ordered set and any relationship between set symbols in the string of symbols and the data in the ordered set is possible as long as the data can be located from the position of the symbol associated with the key in the bit string. The method of finding a perfect hash function for a set of keys can be used with any function ƒ(s,p) for which there is a high probability that a set of values P of p can be found which includes at least one value of p that will yield a hash function that is perfect for the set of keys.

The manner in which the apparatus and methods embodying the inventions are implemented will further depend on the nature of the keys and the data, the system in which the invention is implemented, and the idiosyncrasies of the implementers. For all of the foregoing reasons, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

What is claimed is:

1. A representation in storage accessible to a computer system of items of data associated with a set of keys that are used in the computer system to locate the associated items of data, the representation comprising:
a string of symbols, the value of a symbol in the string indicating whether the symbol corresponds to one of the keys in the set; and
an ordered set of the items of data wherein there is an item of data corresponding to each symbol that corresponds to a key and the position of the item of data in the ordered set is such that the item of data may be located in the ordered set using the position of the symbol onto which the key has been mapped.

2. The representation of items of data set forth in claim 1 wherein:
each of the keys has exactly one symbol corresponding thereto in the string, whereby each item of data appears only once in the ordered set of items.

3. The representation of items of data set forth in claim 2 wherein:
a symbol corresponding to a key has an index in the string which is the result of applying a hash function to the key which is perfect with regard to the set of keys.

4. The representation of items of data set forth in claim 3 wherein:
the hash function is ƒ(s,p) where s is the key and p is a value such that the hash function is perfect with regard to the set of keys.

5. The representation of items of data set forth in claim 4 wherein:
mod p is a factor of the result of ƒ(s,p).

6. The representation of items of data set forth in claim 5 wherein:
the value of p is a member of a set of co-prime numbers.

7. The representation of items of data set forth in claim 1 further comprising:
a hash function specifier which specifies a particular hash function ƒ(s,p).

8. The representation of items set forth in claim 7 wherein:
the hash function specifier is included in the string of symbols.

9. The representation of items of data set forth in claim 7 wherein:
the hash function specifier specifies a value of p.

10. A storage device characterized in that:
the storage device contains code which, when executed by a processor, produces the representation set forth in claim 1.

11. A method of finding a hash function ƒ(s,p) for a set of keys, the method comprising the steps of:
defining a set of values P such that P has a high probability of including a value p such that ƒ(s,p) is perfect for the set of keys; and
repeating the steps of
selecting a value of p from P; and
testing ƒ(s,p) with the selected p and the set of keys to determine whether ƒ(s,p)
with the selected p is perfect for the set of keys until a value of p is found for which ƒ(s,p) is perfect for the set of keys or all of the values of p have been tested.

12. The method set forth in claim 11, wherein:
mod p is a factor of the result of ƒ(s,p).

13. The method set forth in claim 12, wherein:
P is a set of co-prime numbers.

14. The method set forth in claim 13 further comprising the step of:
using a further set of co-prime numbers if no perfect hash function is found for a current set of co-prime numbers.

15. The method set forth in claim 11, further comprising the step of:
reducing the number of keys in the set thereof if no perfect hash function is found.

16. A storage device characterized in that:
the storage device contains code which, when executed by a processor, implements the method set forth in claim 11.

17. A method of making a representation in storage accessible to a computer system of items of data associated with keys belonging to a set of keys, the keys being used in the computer system to locate the associated items of data in the representation, the representation including a string of symbols and an ordered set of the items of data, and the method comprising the steps of:
for each key in the set of keys,
mapping the key onto a symbol of the string of symbols;
setting the symbol onto which the key has been mapped; and
placing the item of data associated with the key in the ordered set, the position of the item of data in the ordered set being such that the item of data may be located using the position of the symbol onto which the key has been mapped.

18. The method set forth in claim 17 wherein:
there are exactly as many elements in the ordered set as there are items of data associated with the keys.

19. The method set forth in claim 18 wherein:
a given item of data appears only once in the ordered set.

20. The method set forth in claim 19 wherein:
in the step of mapping, a hash function which is perfect with regard to the set of keys is used to map the key to the symbol.

21. The method set forth in claim 20 further comprising the step of:
finding a perfect hash function for the set of keys.

22. A method of locating an item of data in a representation in storage accessible to a computer system, the items of data being associated with keys belonging to a set of keys, the representation including a string of symbols and an ordered set of the items of data, and the method comprising:
mapping the key to a set symbol in the string of symbols;
determining the position of the set symbol relative to other set symbols in the string; and
using the position of the set symbol to locate the item of data corresponding to the key in the ordered set.

23. The method set forth in claim 22, wherein:
the string of symbols is a bit string.

24. The method set forth in claim 22 wherein:
in the step of mapping, a hash function which is perfect with regard to the set of keys is used to map the key to the symbol.

25. The method of claim 23, wherein
the representation further includes a specifier for the hash function and the method further comprises the step of:
using the specifier to obtain the hash function.
